(19) United States
(12) Patent Application Publication
(10) Pub. No.: US 2010/0025495 A1
(43) Pub. Date: Feb. 4, 2010

(54) SPRAY DEVICE HAVING AT LEAST TWO VECTOR GAS OUTLET ORIFICES

(75) Inventors: Philippe Bonningue, Paris (FR); Jean-Pierre Yquel, Colombes (FR)

Correspondence Address: PEARNE & GORDON LLP, 1801 EAST 9TH STREET, SUITE 1200, CLEVELAND, OH, 44114-3108, US

(73) Assignee: L'Oreal, Paris (FR)

(21) Appl. No.: 12/537,533

(22) Filed: Aug. 7, 2009

Related U.S. Application Data
(62) Division of application No. 09/999,860, filed on Oct. 23, 2001, now abandoned.

(30) Foreign Application Priority Data
Oct. 24, 2000 (FR) 00 13610
Oct. 11, 2001 (FR) 01 13098

(51) Int. Cl. B05B 7/30

(52) U.S. Cl. 239/340; 239/422; 239/433

(57) ABSTRACT

A device for spraying at least one substance onto a medium, the device comprising a supply of vector gas and at least one substance feed member suitable for communicating with a supply of said substance, the substance being sucked from the supply by suction established in the vicinity of the substance feed member by means of the vector gas being emitted, wherein the vector gas is emitted through at least two gas outlet orifices whose respective positions are selected in such a manner that the vector gas jets emitted by said orifices meet one another.

### CROSS-REFERENCE TO RELATED APPLICATIONS

This application is a divisional application of application Ser. No. 09/999,860, filed Oct. 23, 2001.

### FIELD OF THE INVENTION

The present invention relates to a device for spraying at least one substance onto a medium, in particular onto a keratinous medium such as the skin.

### BACKGROUND OF THE INVENTION

The use of a vector gas jet for spraying paint has been known for a long time, in particular from U.S. Pat. No. 2,635,921.

That principle has been developed thoroughly and constitutes the subject matter of numerous patent applications.

As an indication, mention can be made of European patent application No. EP-A1-0 208 247 and of U.S. Pat. Nos. 5,255,852 and 5,713,519. In U.S. Pat. No. 5,713,519, the vector gas feeds two nozzles, and two different liquids are injected into the nozzles to mix outside the device when the jets emitted by the nozzles meet each other.

French patent application No. FR-A-2 781 208 discloses a device for spraying a composition onto a medium, the composition being selected from a plurality of compositions having different tints, in which the composition is sprayed by suction generated by a vector gas jet expanding in the vicinity of a composition feed member, the vector gas jet being emitted through a nozzle whose axis is contained in the same plane as that of the feed member.

Spray devices are also to be found on the market under the trademark Ecospray®, which devices are suitable for applying paint on a non-keratinous medium but do not enable satisfactory results to be obtained when used with cosmetics.

U.S. Pat. No. 1,430,506 discloses a device which comprises a tank on which two nozzles are fixed that are connected to a compressed air inlet, the two nozzles being suitable for emitting jets of air that meet in a region situated over a substance feed orifice. Such a device requires an external source of compressed air and does not constitute a self-contained device.

It is also known to apply makeup by means of an airbrush comprising an applicator stylus connected to a cylinder of compressed vector gas, the applicator stylus comprising firstly a vector gas ejection nozzle and secondly a cup containing the makeup to be applied, the makeup being sucked progressively via a duct into the cup by means of the suction created by the Venturi effect due to the speed of the vector gas on leaving the nozzle. Airbrush type application serves in particular to make the boundary between treated zones and non-treated zones less visible, to produce blending and shading-off effects or impressions of volume. Hand action is also different since makeup that has been sprayed on does not need to be spread out after it has been deposited on the keratinous medium. Makeup is thus applied very hygienically since application can be done without making contact with the fingers or with an applicator.

A device as described above constitutes the subject matter of Canadian patent application No. CA-A-2 152 406, for example. Similar devices are sold by DINAIR under registered trademarks BEAUTY ART and BODY ART, with the cylinder of compressed vector gas being replaced by an air compressor. In those known devices the applicator stylus and the vector gas source do not constitute a unitary structure since they are interconnected by a hose, and as a result those devices are relatively bulky and are intended mainly for professional use. They are not easy for a woman to carry about in her handbag, like conventional makeup accessories.

### OBJECTS AND SUMMARY OF THE INVENTION

An object of the present invention is to provide a novel spray device of relatively simple structure and low cost which is suitable for use in particular in the field of cosmetics.

The spray device of the invention presents a one-piece structure, and comprises a supply of vector gas and at least one substance feed suitable for communicating with at least one supply of said substance, the substance being taken from the supply by suction established in the vicinity of the substance feed by a flow of the vector gas.

In the device the suction results from the vector gas being emitted via at least two gas outlet orifices having respective positions, i.e. orientations and spacing, that are selected in such a manner that the jets of vector gas emitted by these orifices meet one another.

Because the vector gas jets collide, it is possible to obtain better control over the shape of the resulting spray and the manner in which the substance is sprayed.

The Applicant has thus found that by using such a device it is possible to obtain results that are particularly satisfactory in cosmetics, in particular for applying makeup on the hair, the skin, or the fingernails.

The device of the invention is a one-piece structure, i.e. it does not have to be fastened to a source of compressed air external to the device and can be relatively small in size, e.g. of a size that can be carried in a handbag.

The gas outlet orifices can be disposed symmetrically about the spray axis.

In a particular embodiment, since the substance feed includes at least one orifice, the axes of the gas outlet and substance feed orifices can be directed towards the surface on which the substances is sprayed.

The substance feed orifice(s) can be situated between the gas outlet orifices when the device is observed from the surface on which the substance is sprayed.

The feed member has an end through which the substance leaves, said end being located, for example, substantially in the same plane as the axes of the gas outlet orifices.

The feed member can have an axis which is coplanar with the axes of the gas outlet orifices, or in a variant an axis which is perpendicular to the spray axis.

In a particular embodiment, the feed member comprises a tube in which the substance can flow.

In a variant embodiment, when the substance is a liquid, the feed member is made of a porous material suitable for enabling the substance to be transported by capillary action, and in particular it is made of a felt or a sintered material.

The gas outlet orifices can be arranged in such a manner that the emitted gas jets meet one another directly, without being deflected by any deflector-forming element.

In a variant, the gas outlet orifices can be arranged so that the emitted gas jets meet one another after being deflected, at least in part, by at least one deflector-forming element.

In a particular embodiment, the axes of the gas outlet orifices meet without intersecting the deflector-forming element.

In a variant, the axes of the gas outlet orifices are tangential to a surface of the deflector-forming element.

The axes of the gas outlet orifices can also intersect the edge of an angular portion of the deflector-forming element.

The deflector-forming element can be constituted at least in part by a surface of the substance feed member.

In a particular embodiment, the deflector-forming element has a hollow frustoconical portion forming a substance outlet nozzle.

The angle at the apex of the generator line for the frustoconical portion relative to the spray axis can be less than or equal to 45°.

The gas outlet orifices can be set back from a free end of the feed member through which the substance leaves.

The gas outlet orifices can be free from any swirl channels.

In a particular embodiment, the axes of the gas outlet orifices are at an angle of about 45° relative to the spray axis.

In a particular embodiment, the device has two substance outlet orifices, of axes parallel to the spray axis.

Still in a particular embodiment, the device has a receptacle suitable for containing the vector gas in liquefied form.

The vector gas is compatible with the spray device being used in cosmetics, where the substance is for spraying onto a keratinous medium. The use of a vector gas in liquefied form enables the spray device to operate for a satisfactory length of time and enables the vector gas to be fed at a constant pressure, thus giving easier control over spraying the substance.

The substance supply can be contained in a removable receptacle, thus making it possible to change the substance from one use to another, for example.

The substance supply can be contained in a receptacle that is arranged to be capable of being supported by the receptacle containing the vector gas, thus making the assembly easier to handle.

In particular, the substance supply can be contained in a receptacle arranged to be screwed onto the receptacle containing the vector gas.

The substance supply can also be contained in a receptacle capable of being turned relative to the receptacle containing the vector gas, thus making it possible to change the sprayed substance merely by turning the receptacle, when the receptacle contains two different substances that are stored separately.

The diameter of the gas outlet orifices lies, for example, in the range of about 0.2 millimeters (mm) to about 0.5 mm, and for example in the range 0.3 mm to 0.4 mm.

The feed member can have a substance outlet orifice of diameter that lies in the range of about 0.7 mm to about 1 mm for example, and more in the range 0.8 mm to 0.9 mm for example.

The substance supply can, for example, be contained in a receptacle that does not have an air intake duct, other than the substance feed member, thus ensuring that the feed member is cleaned automatically when spraying stops, with any substance contained in the feed member being sucked back into the receptacle.

In a variant, the receptacle can include means that enable air to be admitted, such as, for example, a microleak or a valve that is capable of opening in the event of a drop in pressure in the receptacle containing the substance. If a microleak is used, it is made in such a manner as to prevent substance from passing therethrough when the device is in a prone position.

In order, for example, to avoid the risk of substance leaking out when the device is carried lying down in a handbag for example, and/or in order to improve conservation of the substance by limiting, for example, the risk of volatile components evaporating, the device can be organized in such a manner as to enable fluid communication between the supply of substance and the substance feed to be interrupted.

Thus, the device can comprise a supply of vector gas, at least one substance feed suitable for being put into fluid communication with a supply of said substance, the substance being sucked from the supply by suction established in the vicinity of said at least one substance feed by emission of the vector gas.

According to an aspect of the invention, the device further comprises at least one shutter suitable for interrupting fluid communication between said at least one substance feed and the supply of substance.

The conditions under which the substance is conserved in the supply of substance can thus be improved, and in particular it is possible to prevent volatile components from escaping.

That can also make it possible to avoid the risks of substance leaking out while the device is being carried about in a horizontal or an upside-down position, as can happen for example in a handbag.

According to an aspect of the invention, the device can be arranged in such a manner as to reestablish fluid communication automatically between said at least one substance feed and the substance supply whenever the vector gas is emitted. The device can thus be arranged in such a manner that fluid communication is automatically interrupted whenever vector gas emission stops.

According to an aspect of the invention, the device can include a pushbutton suitable for acting simultaneously, whether directly or indirectly, on a vector gas dispenser valve and on the shutter so that fluid communication between the substance feed and the supply of substance is established when the user presses on the pushbutton to deliver the vector gas.

The supply of substance can be contained, for example, in a first receptacle fixed to a second receptacle containing the vector gas. The two receptacles can also have at least one portion in common, e.g. a partition defining at least two compartments respectively containing the vector gas and the substance to be sprayed.

The receptacle containing the substance and the receptacle containing the vector gas can be in fixed relationship, neither being capable of moving relative to the other in use. By way of example this makes it possible to obtain an assembly that is relatively compact and easy to carry about, in particular in a handbag.

The receptacle containing the substance can, for example, be annular in shape so as to leave a passage, e.g. a central passage, along which a control member for a valve fitted to the receptacle containing the vector gas can extend.

The shutter can be operationally connected to at least one element actuated by moving the pushbutton of the device. Such an element can comprise a hollow rod, for example, the rod having at least one internal passage enabling the substance contained in the supply of substance to reach the substance feed.

By way of example, the shutter can comprise at least one gasket suitable for closing at least one orifice through which the substance can flow to reach said at least one substance feed, and suitable for releasing said orifice at least in part while the substance is being dispensed.

In a particular embodiment, the shutter is constituted by a gasket mounted on a hollow rod, the rod being closed at its bottom end, the gasket being capable of bearing via its top face against a shoulder of the rod. The rod is pierced by at least one substance admission orifice, for example, of a diameter that is smaller than or equal to the thickness of the gasket. The gasket is suitable for coming into abutment via its bottom face against a fixed bearing wall when the hollow rod is pushed down, so that the gasket is then compressed and disengages the admission orifice at least in part, so as to allow substance to flow towards said at least one substance feed. By way of example, the gasket can also press via its periphery against the inside surface of a duct in which the hollow rod can move axially, said duct being capable of communicating freely with the outside, in which case the gasket makes it possible to obtain leaktight closure of the gap situated between the hollow rod and the inside surface of the duct. The top end of the duct can connect to a cover closing the top of the substance containing receptacle, for example. The hollow rod can be actuated by moving the pushbutton that controls vector gas emission, for example. The inside space at the bearing wall against which the gasket can come into abutment via its bottom face can communicate with the receptacle containing the substance, e.g. via an annular channel formed in a bottom end wall of the receptacle. The above-mentioned duct can be connected in leaktight manner to the above-mentioned tubular bearing wall.

According to an aspect of the invention, the device can comprise a pushbutton made by assembling together a bottom portion and a top portion. The bottom portion can be made integrally with an actuator rod, for example, and can extend in a passage of the receptacle containing the substance, e.g. a central passage. The control rod for the valve delivering the vector gas can be engaged in the actuator rod of the pushbutton.

The substance which is sprayed can be a liquid, a liquid containing solid particles in suspension, or a powder that is sufficiently fine. The term “spray” should therefore be understood broadly as covering not only projecting liquid droplets, but also projecting dry particles, more commonly known as “dusting” or “blowing”.

### BRIEF DESCRIPTION OF THE DRAWINGS

Other characteristics and advantages of the present invention will appear on reading the following detailed description of non-limiting embodiments of the invention, and on examining the accompanying drawing, in which:

FIG. 1 is a diagrammatic perspective view of a spray device constituting a first embodiment of the invention;

FIG. 2 is a diagrammatic and fragmentary plan view of a spray head shown in FIG. 1;

FIGS. 3 and 4 are fragmentary sections showing two variant embodiments of the spray head;

FIG. 5 is a diagrammatic fragmentary section view of a spray device constituting a second embodiment of the invention;

FIG. 6 shows a variant embodiment of a feed member for the spray device of FIG. 5;

FIG. 7 is a fragmentary diagrammatic axial section on VII-VII of FIG. 8, showing an embodiment of a spray device in accordance with the invention;

FIG. 8 is a diagrammatic and fragmentary plan view as seen looking along arrow VIII in FIG. 7;

FIG. 9 is a fragmentary and diagrammatic axial section on IX-IX of FIG. 8;

FIG. 10 is a fragmentary diagrammatic exploded perspective view of the FIG. 7 device;

FIG. 11 is a view on a larger scale showing detail of area XI of FIG. 7 and illustrating a shutter;

FIGS. 12 and 13 are diagrams showing other examples of shutters;

FIG. 14 is a diagram of a member for feeding substance by capillarity;

FIG. 15 is a diagram showing an example of a microleak; and

FIG. 16 is a diagram showing an example of an air intake valve.

### MORE DETAILED DESCRIPTION

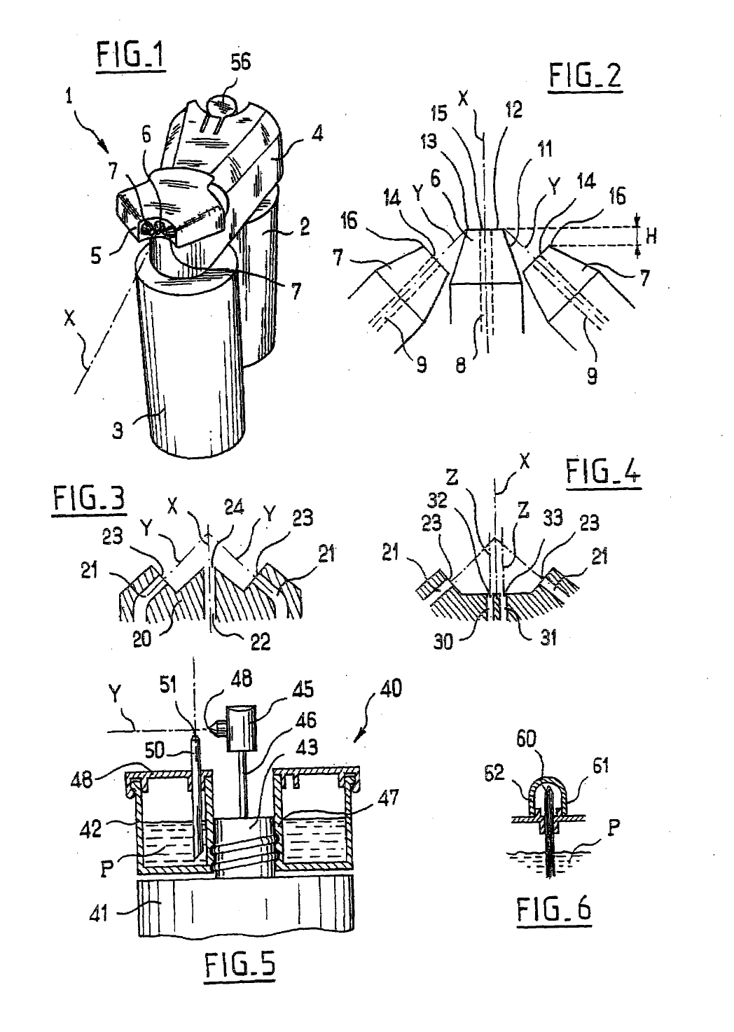

FIG. 1 shows a spray device 1 constituting a first embodiment of the invention, and comprising a first receptacle 2 containing a supply of vector gas and a second receptacle 3 containing a substance for spraying.

In the example described, the vector gas is present in the liquefied state in the receptacle 2 and it is selected to be of a nature that is compatible with spraying onto a keratinous medium such as the skin, the fingernails, or the hair.

Naturally, it would not go beyond the ambit of the present invention to use other vector gases, for example compressed air or nitrogen, and for the medium onto which the substance contained in the receptacle 3 is sprayed to be non-keratinous.

In addition to the receptacles 2 and 3, the spray device 1 also comprises a dispenser unit 4 comprising a spray head 5 and an actuator member 56 such as a pushbutton.

The spray head 5 has a spray axis denoted X. The spray head 5 has a central nozzle 6 for dispensing the substance contained in the receptacle 3, and two side nozzles 7 for emitting the vector gas.

The nozzles 6 and 7 are shown in greater detail in FIG. 2.

The nozzle 6 has an inside passage 8 on an axis X, which axis coincides with the spray axis.

Each of the nozzles 7 has an inside passage 9 on a respective axis Y, each of the axes Y forming an angle of 45o with the axis X and both being contained in the same plane as the axis X.

The passage 8 is permanently in communication with the substance contained in the receptacle 3, and the passages 9 communicate with the vector gas contained in the receptacle 2 via a valve which is actuated by the pushbutton 56.

Each of the inside passages 9 of the nozzles 7 terminates at a respective vector gas outlet orifice 14. The inside passages 8 of the nozzle 6 terminates at a substance outlet orifice 15.

The vector gas outlet orifices 14 have a diameter of 0.4 mm, for example, and the substance outlet orifice 15 has a diameter of 0.9 mm, for example.

Also, in the illustrated example, the vector gas outlet orifices 14 do not contain any swirl channels that would cause a rotation of the vector gas. In general, swirl channels and chambers rely on the introduction of flow along a tangential direction to impact rotation and to develop angular momentum. Such structure is not necessary in the present invention, although it is possible to include such structure.

When the user presses on the pushbutton 56, the vector gas travels along the passages 9 and expands on leaving the nozzles 7, which, by the Venturi effect, leads to the pressure in front of the nozzles 6 being lowered and to substance being sucked into the passage 8.

Given the directions in which the axes Y are oriented, the vector gas jets emitted by the nozzles 7 meet each other, thus making it possible to obtain a spray having particle size characteristics and overall spray shape characteristics that are compatible with obtaining satisfactory results when applying substance onto a keratinous medium.

In the particular configuration shown in FIG. 2, the nozzle 6 also acts as a deflector-forming element and deflects a fraction of each of the vector gas jets emitted by the nozzles 7 in a forward direction.

In other words, at least a part of each vector gas jet strikes the nozzle 6, whereupon the jets take up orientations that are closer to that of the spray axis.

It will be observed that the nozzle 6 has a hollow frustoconical portion 11 having a generator line which makes an angle with the spray axis X that is less than the angle made by each of the axes Y with the axis X.

In the example shown in FIG. 2, the nozzle 6 has an end face 12 which is plane and perpendicular to the axis X, and the axis Y of each nozzle 7 intersects a circular edge 13 of the end face 12.

The distance H between the end face 12 of the nozzle 6 and an edge 16 of the front face of each nozzle 7 is about 1.7 mm, for example.

In the embodiment of FIGS. 1 and 2, the nozzles 6 and 7 are constituted by separate fitted pieces.

Naturally, it would not go beyond the ambit of the present invention for the substance outlet orifice and the vector gas outlet orifices to be constituted by the ends of inside passages formed in a one-piece block, as shown in FIG. 3.

This figure shows a spray head 20 pierced by side passages 21 communicating with the supply of vector gas, and a central passage 22 communicating with the supply of substance and opening to the outside via an orifice 24 on the axis X.

The passages 21 open to the outside via distinct orifices 23 on axes Y that intersect the axis X.

In the embodiment of FIG. 3, the vector gas jets emitted by the passages 21 strike each other directly without prior deflection on a deflector-forming element such as the nozzle 6 described above.

The invention is not limited to dispensing a single substance and, without going beyond the ambit of the present invention, it is possible to mix at least two substances, one of the substances being contained in the receptacle containing the vector gas and being entrained with said gas.

The two substances can also be contained in two distinct receptacles, different from the receptacle containing the vector gas.

Under such circumstances, the substance feeds can be provided via two separate paths, as shown in FIG. 4.

In this figure, the passage 22 has been replaced by two passages 30 and 31 communicating respectively with two different supplies of substance, e.g. two substances that need to be packaged separately, and then mixed together extemporaneously.

The axes Z of the orifices 32 and 33 of the passages 30 and 31 are parallel to the spray axis X.

The spray axis X can be horizontal or it can have some other orientation, depending on the ergonomic requirements of the spray device and on the location of the zone to be treated.

The spray device can be designed to be capable of operating with its head up or down.

The substance can be contained in a removable receptacle, as described below with reference to FIG. 5.

This figure shows a device 40 containing a receptacle 41 containing a vector gas, and a receptacle 42 containing a supply of substance P.

The receptacle 41 is provided with a threaded neck 43.

The spray head 45 is fixed on the hollow control rod 46 of the valve of the receptacle 41.

The receptacle 42 has an annular assembly skirt 47 arranged to screw onto the threaded neck 43.

The receptacle 42 is closed in leaktight manner at the top by a lid 48.

The pushbutton 45 has two vector gas dispensing orifices 48 at an angle to each other and having axes Y that intersect substantially vertically over a substance feed member 50 constituted in the example shown in FIG. 5 by a tube dipping to the bottom of the receptacle 42.

The tube 50 passes through the lid 48 in leaktight manner.

The top end of the tube 50 is provided with an orifice 51 enabling the substance to escape under the effect of the suction established by the orifices 48 ejecting the vector gas when the user presses on the pushbutton 45.

By having the receptacle 42 removably fixable on the receptacle 41, the user can reestablish the supply of substance when it has been used up by replacing the receptacle 42 with a new receptacle that is full of substance.

By means of the receptacle 42 being removably mounted on the receptacle 41, the user can also select one particular receptacle 42 selected from a plurality of receptacles containing different substances, e.g. substances of different colors.

Thus, the user makes use of a single receptacle 41 containing vector gas in association with a selected receptacle 42 taken from a plurality of receptacles containing different substances.

It is appropriate to observe that the receptacle 42 does not have any air intake orifice other than the inside passage of the tube 50.

When the substance is dispensed on the pushbutton 45 being actuated, suction is established in the receptacle 42, and when dispensing stops, the return to equilibrium pressure inside the receptacle 42 is accompanied by substance going back down along the tube 50, thus providing a kind of self-cleaning of the tube 50 and reducing the risk of the tube becoming blocked.

Naturally, the feed member is not limited to a tube into which the substance is sucked, and the tube 50 could be replaced, for example, by a material capable of absorbing the substance P by capillarity, e.g. a wick, a felt, or a sintered member.

FIG. 6 shows a felt tip 60 replacing the tube 50 of FIG. 5, the lid 48 then being provided with a skirt 61 enabling a removable closure cap 62 to be secured which isolates the felt tip 60 from ambient air during periods of non-use and prevents it from drying out.

The invention is not limited to the embodiments described above.

In particular, it is possible to mount a plurality of supplies containing different substances in respective chambers of a rotary cylinder similar to that described in above-mentioned French patent application FR-A-2 781 208.

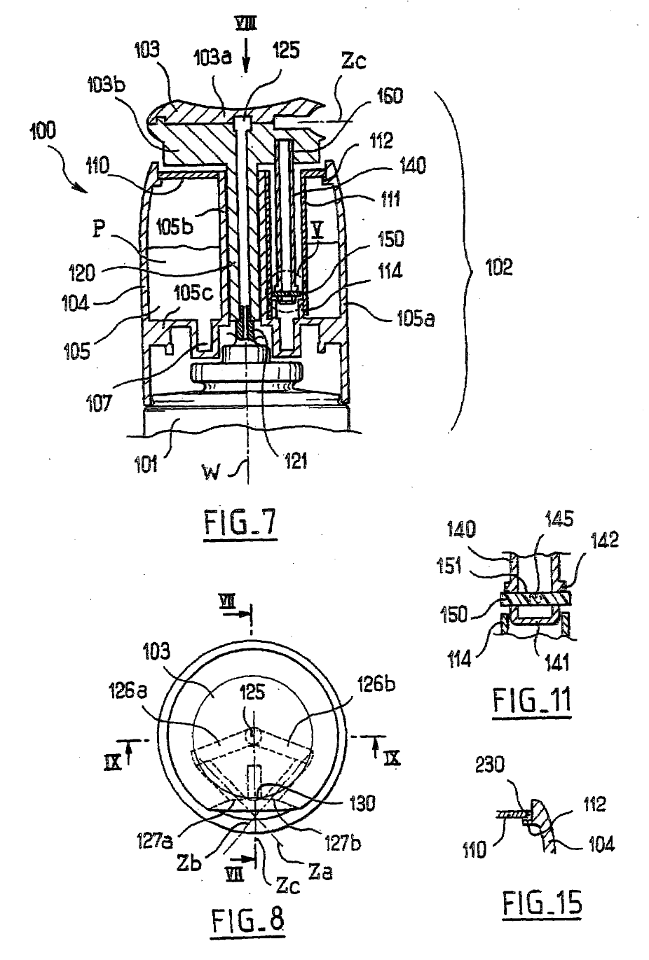

The spray device 100 shown in FIG. 7 comprises a pressurized receptacle 101 containing a vector gas in liquefied form, e.g. butane, isopropane, isobutane, or a fluorinated compound, and a dispenser assembly 102 comprising a pushbutton 103 and a receptacle 104 containing a substance P, e.g. a liquid foundation makeup. By way of example, the substance P can be a liquid containing solid particles in suspension.

In the example described, the receptacle 104 has a cavity 105 that is generally annular in shape about an axis W, said cavity 105 containing the substance P being defined radially on the outside by a first tubular wall 105a and radially on the inside by a second tubular wall 105b. The walls 105a and 105b are united at the bottom by a bottom end wall 105c which includes an annular channel 107 about the axis W, whose function is explained below.

The top of the cavity 105 is closed by a cover 110 with a duct 111 having its axis parallel to the axis W being connected to the bottom face of the cover. The cover 110 can bear against a shoulder 112 formed at the top end of the wall 105a.

The duct 111 extends over substantially the entire height of the cavity 105 and its bottom end is assembled to a wall 114 which projects upwards from the bottom wall 105c vertically over the channel 107. The duct 111 can be assembled to the wall 114 by engaging one within the other, for example. The above-mentioned wall 114 can be continuous or discontinuous, and for example it can be constituted by studs.

The duct 111 and the cover 110 can be formed integrally, for example.

The pushbutton 103 is made, for example, by assembling together a top portion 103a and a bottom portion 103b. In the example shown, the bottom wall is formed integrally with a hollow rod 120 for actuating a valve of the pressurized receptacle 101, the rod being capable of sliding inside the wall 105b.

This valve can itself have a hollow control rod 121 engaged in leaktight manner in the bottom end of the rod 120, and bearing via a shoulder against the bottom end face of the rod 120.

The pushbutton 103 can be moved along the axis W to act on the control rod 121, thus causing the vector gas to flow along the duct inside the rod 120 so as to reach a cavity 125 which is in communication, as can be seen in FIG. 8, with two internal ducts 126a and 126b opening to the outside of the pushbutton via vector gas outlet orifices 127a and 127b. The orifices 127a and 127b have axes Za and Zb that are substantially perpendicular to each other, for example, each being at an angle of about 45° relative to the spray direction, for example.

The pushbutton 103 also has a substance feed orifice 130 having an axis Zc which coincides with the spray direction, for example. The orifice 130 communicates with the inside of a hollow rod 140, for example, which rod is closed at its bottom end by a wall 141, as can be seen in FIG. 11, and on which a shutter-forming annular gasket 150 is engaged, the gasket 150 being made of elastomer, for example.

In the example shown, the gasket 150 bears via its plane top face 151 against an annular rib 142 of the rod 140. The rod has at least one substance admission orifice 145 whose diameter is less than or equal to the nominal thickness of the gasket 150 as measured along the axis of the rod 140. The orifice 145 is positioned in such a manner that the gasket 150, when bearing at rest against the rib 142, covers the orifice 145 completely and prevents the substance P contained in the cavity 105 from penetrating via the orifice 145 into the rod 140.

By way of example, the rod 140 is fixed via its top end in a housing 160 of the pushbutton 103 and can move together with the rod 120 when the user presses on the pushbutton 103. When the rod 140 is pushed down, the gasket 150 is compressed between the wall 114 and the rib 142 with such compression having the effect of reducing its thickness and releasing the orifice 145, at least in part, so that the substance contained in the cavity 105 can flow through the orifice 145, up the rod 140, and reach the substance feed orifice 130.

When the pushbutton 103 is released, the rod 140 rises together with the pushbutton so the gasket 150 can return to a thickness which is sufficient for closing the orifice 145 because of the gasket's shape memory.

The device 100 operates as follows. To spray substance P, the user presses on the pushbutton 103, thereby pushing down the rod 11 of the valve on the receptacle and causing vector gas to be emitted into the passage inside the rod 120. The vector gas flows via the duct 126a and 126b so as to leave via the orifices 127a and 127b, thereby establishing suction in front of the substance feed orifice 130 by the Venturi effect pushing down the pushbutton 103 also has the effect of moving the rod 140 so as to compress the gasket 150 as explained above. The orifice 145 is then released at least in part and substance P contained in the cavity 105 can rise up the passage inside the rod 140 and reach the orifice 130 due to the effect of the above-mentioned suction. The substance is then sprayed along the direction of the axis Zc so long as the user continues to press on the pushbutton 103. When the pushbutton is released, it can rise back into its rest position because the control rod 121 is returned into its initial position by resilient means specific to the receptacle 101, and also because the gasket 150 has its own elasticity. By returning to its initial shape, the gasket closes the orifice 145 so that if ever the device 100 is carried about in a horizontal or an upside-down position, the substance P remains contained inside the cavity 105 and does not run any risk of leaking out through the substance feed orifice 130. By way of example, the receptacle 104 can be secured removably to the receptacle containing the vector gas, so as to make it possible, where appropriate, to change receptacle 104 when the supply of substance is used up. This can also enable the receptacle 101 to be replaced, or enable different substances to be sprayed in succession using a single receptacle 101.

In the embodiment corresponding to FIGS. 7 to 11, the substance feed is constituted by the end of a duct formed in the pushbutton, however it would not go beyond the ambit of the present invention for the substance feed to comprise a material capable of absorbing the substance by capillarity, e.g. a wick, a felt, or a sintered material.

Naturally, the invention is not limited to the embodiments described above, and in general, the above-described shutter can be replaced by any suitable shutter means, e.g. shutter means as shown in FIG. 12 comprising two coaxial walls 201 and 202 that are movable relative to each other and that constitute a shutter.

By way of example, the inner wall 202 can be formed by a hollow rod secured to the pushbutton and closed at its bottom end. The substance can rise inside said rod when suction is established by emitting the vector gas.

The outer wall 201 is stationary and it is suitable for closing an orifice 203 through the wall 202 when the pushbutton is at rest. The wall 202 has an orifice 204 suitable for coming into register with the orifice 103 when the pushbutton is pressed down, thereby at least partially releasing the orifice 203 so as to allow the substance to reach the substance feed.

A check valve, e.g. in the form of a ball, suitable for being opened by moving the pushbutton could also be used, as shown in FIG. 13. Such a check valve can occupy a closed position when the pushbutton is released by the user. In the example shown, the check valve has a shutter-forming ball 210 urged into a shut position by a spring 211. An actuator rod 212 is arranged to be moved downwards when the pushbutton is pushed down. The substance can then flow via a duct 213 to reach the zone where the suction is established, in order to be sprayed.

In variant embodiments, the annular channel 107 could be omitted, e.g. if the substance is allowed to reach the space inside the wall 114, e.g. through openings formed in said wall and in the bottom end of the duct 114.

It would not go beyond the ambit of the invention for the substance feed to include a substance feed member such as a felt, a foam, or a sintered member, as shown in FIG. 14. In this figure, there can be seen a felt tip 220 serving to feed the substance by capillary action into the zone where suction is established, said felt tip being fixed in the above-mentioned orifice 130, for example.

The control rod 121 for the receptacle containing the vector gas could also cause the vector gas to be dispensed by being tilted relative to the axis W, providing the pushbutton is designed accordingly.

The receptacle 104 can be made without air intake, or else with air intake, in particular if extended use is envisaged.

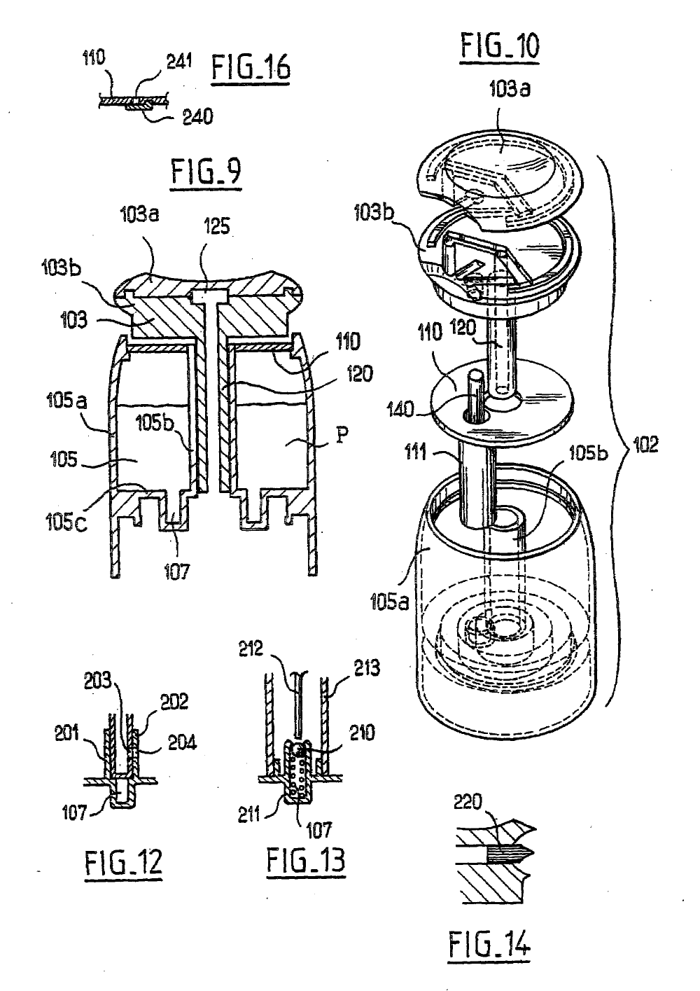

To enable air intake, it is possible, for example, to make a microleak 230, as shown in FIG. 15, through the cover 110 or between the cover and the wall 105a of the receptacle, which corresponds to the example shown in FIG. 9. Such a microleak is made in such a manner as to prevent substance passing therethrough, in particular when the device is in a prone position, but to enable air to pass therethrough.

As shown in FIG. 16, a valve 240 that is capable of closing an air intake orifice 241 can also be provided, for example. The valve 240 is opened in the event of a drop in pressure inside the receptacle containing the substance and closes the orifice 241 in the opposite event.

The valve 240 can, for example, be overmolded onto the cover 110, but could also be made in some other way without going beyond the ambit of the invention.

What is claimed is:

1. A hand held device for spraying at least one cosmetic substance onto a medium along a spray axis, comprising:
a supply of vector gas,
at least one supply of said cosmetic substance,
at least one substance feed member suitable for communicating with said supply of said substance, the substance being taken from the supply of substance by suction established in the vicinity of the substance feed member by the vector gas being emitted, wherein the vector gas is emitted through at least two gas outlet orifices whose respective positions are selected in such a manner that the vector gas jets emitted by said orifices meet one another, no cosmetic substance is emitted through the at least two gas outlet orifices, wherein the device is of one-piece construction and is configured for being carried by a handbag; and
at least one shutter suitable for interrupting fluid communication between said at least one substance feed member and the supply of substance, the device being arranged in such a manner as to reestablish fluid communication automatically between said at least one substance feed and the supply of substance while vector gas is being emitted.

2. A device according to claim 1, comprising a pushbutton suitable for acting simultaneously, directly or indirectly, on a vector gas dispenser valve and on the shutter, whereby fluid communication between said at least one substance feed and the supply of substance is established when the user presses on the pushbutton to cause the vector gas to be dispensed.

3. A device according to claim 1, wherein the shutter is operationally connected to at least one element actuated by moving the pushbutton of the device.

4. A device according to claim 1, wherein the shutter comprises at least one gasket suitable for shutting at least one orifice through which the substance can flow to reach said at least one substance feed, and suitable for releasing said orifice at least in part while substance is being dispensed.

5. A device according to claim 4, wherein the shutter is constituted by a gasket mounted on a hollow rod, the rod being closed at its bottom end, the gasket being capable of bearing via its top face against a shoulder of the rod, the rod having at least one substance admission orifice passing therethrough, the orifice being of a diameter that is smaller than or equal to the thickness of the gasket, said gasket being suitable for coming into abutment via its bottom face against a stationary bearing wall when the hollow rod is pushed down, thereby causing the gasket to be compressed so as to release the admission orifice at least in part, thus enabling substance to flow towards said at least one substance feed.

6. A device according to claim 5, wherein the gasket bears via its periphery against the inside surface of a duct in which the hollow rod can move axially, the duct being capable of communicating freely with the outside.

7. A device according to claim 5, wherein the hollow rod is actuated by moving a pushbutton that controls emission of the vector gas.

8. A device according to claim 5, wherein the space inside the bearing wall against which the gasket can come into abutment via its bottom face communicates with the receptacle containing the substance, via an annular channel formed in a bottom end wall of said receptacle.
